(19) United States
(12) Patent Application Publication
(10) Pub. No.: US 2019/0095557 A1
(43) Pub. Date: Mar. 28, 2019

(54) MODELLING APPARATUSES, METHODS, AND SYSTEMS

(71) Applicant: Credit Suisse Securities (USA) LLC, New York, NY (US)

(72) Inventors: Anurag Sehgal, East Windsor, NJ (US); Oleg N. Baranetz, Fair Lawn, NJ (US); Riaz Shaikh, Hoboken, NJ (US)

(21) Appl. No.: 16/131,984

(22) Filed: Sep. 14, 2018

Related U.S. Application Data
(60) Provisional application No. 62/559,489, filed on Sep. 15, 2017.

(51) Int. Cl. G06F 17/50; G06F 17/18; G06Q 40/06; G06F 16/23

(52) U.S. Cl. CPC G06F 17/5009; G06F 16/2322; G06Q 40/06; G06F 17/18

(57) ABSTRACT

A method for modelling a scenario includes compiling a plurality of data sets; validating the plurality of data sets; determining model execution parameters for executing a set of models selected from among a plurality of models accessible to the modelling platform; automatically executing the set of models in accordance with the execution order to produce an output metric, where the output metric represents a cumulative result of execution of the set of models; creating a database record representative of the model execution parameters utilized to execute the set of models; and storing, by the one or more processors of the modelling platform, the database record in a database accessible to the modelling platform.

### CROSS-REFERENCE TO RELATED APPLICATION

The present application claims priority from U.S. Provisional Application No. 62/559,489, filed Sep. 15, 2017 and entitled, “MODELLING APPARATUSES, METHODS AND SYSTEMS,” the disclosure of which is incorporated by reference herein in its entirety.

### TECHNICAL FIELD

The present subject matter is directed generally to apparatuses, methods, and systems for data processing, and more particularly, to modelling apparatuses, methods and systems.

### BACKGROUND

Following the economic collapse of 2008, regulations requiring financial institutions to perform economic stress testing were imposed. For example, the Dodd-Frank. Act mandates that U.S. banking and financial institutions perform Comprehensive Capital Analysis and Review (CCAR) stress testing. Many other countries have implemented similar requirements, such as the Firm Data. Submission Framework (FDSF) test in the United Kingdom. CCAR and other similar stress tests are designed to evaluate the financial health of entities involved in the banking and finance industry and the results of CCAR testing provide insights into whether or not a tested entity (e.g., a bank) has sufficient capital resources to operate under extreme economic and financial stress conditions. During each CCAR testing period (e.g., each year), a series of hypothetical scenarios designed to represent varying degrees of financial and economic stress are created. These hypothetical scenarios include multiple variables associated with hypothetical economic activity, such as gross domestic product, unemployment rates, stock market prices, interest rates, and the like. Taking these hypothetical scenarios and their associated variables into account, financial institutions must create reports that are submitted for review by the relevant regulatory authorities, such as the Federal Reserve.

The process of performing CCAR stress testing is complex and time consuming. Developing the tools necessary to perform these types of activities is a difficult task and performing these types of activities with existing tools is often time consuming. For example, CCAR testing may involve the creation of large data sets that are used to perform various simulations. Each simulation may require multiple iterations or cycles to be completed and with existing tools it may take days or even weeks to complete once cycle of execution (e.g., one iteration of applying the necessary tool(s) to the applicable data set to achieve a desired output). if an error is subsequently discovered in the data set or if one of the tools utilized during the cycle of execution was not configured properly, the process must be repeated, resulting in significant losses of time and errors.

### SUMMARY

The present application relates to systems and methods for evaluating performance of an entity via modelling techniques. A model execution platform in accordance with aspects of the present disclosure obviates many of the deficiencies and challenges associated with existing modelling techniques applicable to certain model-based analysis approaches, such as techniques fix performing modelling in connection with CCAR stress testing. The disclosed model execution platform provides enhanced management of data sets utilized to perform modelling operations. For example, data sets may be monitored for changes and change records reflecting any detected changes to the data sets may be recorded. The recorded change data enables models to be executed based on snapshots of the data set(s) relevant to a particular time horizon and also enables the model execution platform to be operated in a deterministic manner (e.g., outputs derived from an execution of the model(s) may be reproduced at a subsequent time with the same results despite changes in the underlying data sets). Additionally, data sets (or articular data set snapshots) may be designated as authorized for execution with particular models and/or scenarios, which may prevent invalid data sets from being utilized in connection with execution of certain models,

Additionally, aspects of the disclosed model execution platform may facilitate more accurate modelling and may reduce the amount of time required to complete a model execution cycle. For example, existing CCAR modelling techniques rely on many models developed and executed in isolation and it may take several weeks to complete one execution cycle. In contrast, utilizing a model execution platform in accordance with aspects of the present disclosure may reduce the time required performing a model execution cycle from several weeks to 30 minutes, for example. Additionally, the model execution platform of embodiments utilizes an integrated approach that enables outputs of developed models to be dynamically provided as inputs to other models. This reduces human errors and significantly decreases the amount of time required to complete a model execution cycle. Additionally, the model execution platform may be configured to utilize information that specifies dependencies between models to determine an order in which various models to be executed as part of the model execution cycle are to be performed, thereby reducing instances where models are executed with incomplete data.

Additionally, due to the more rapid model execution capabilities provided by a model execution platform in accordance with the present disclosure, the results of the modelling process may be more accurate. To illustrate, for certain modelling types, such as CCAR stress testing, entities may have a finite amount of time (e.g., 1 month) to develop models appropriate for one or more scenarios, test the models, and then execute the models to obtain the outputs necessary to prepare a report for submission to a regulatory authority. Due to the long execution times and other factors, existing techniques do not provide significant opportunities to evaluate the results of the modelling process and tune/refine the models to more accurately predict the impact that each of the presented scenarios will have. Additionally, if errors in the model execution are discovered, such as utilizing an invalid data set or executing models in an incorrect order, there may not be enough time to correct the errors and re-execute the models to obtain better results. In contrast, the significantly shorter execution times provided by the modeling platforms disclosed herein afford sufficient time to evaluate and tune the model execution process, as described in more detail below. As a result, more accurate reports may be provided to the regulatory agency. Additionally, the disclosed model execution platform may be utilized to improve business intelligence and market analysis. For example, the model execution platform may be utilized to rapidly and accurately analyze various scenarios reflecting possible events that may impact a business' operations, which may allow business personnel to make more informed decisions with respect to developing strategies to manage ongoing business operations and react more rapidly to changing conditions in the relevant market or industry.

The foregoing broadly outlines the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIG. 1 shows a block diagram illustrating exemplary aspects of a block diagram illustrating exemplary aspects of a modelling platform for creating and executing models in accordance with embodiments of the present disclosure;

FIG. 2 shows a diagram illustrating aspects of operations for providing a modelling platform in accordance with embodiments of the present disclosure;

FIG. 3 shows a flow diagram illustrating exemplary aspects of a method for providing a modelling platform according to embodiments of the present disclosure; and

FIG. 4 is a diagram illustrating aspects of a process for utilizing modelling platform in accordance with embodiments of the present disclosure.

It should be appreciated by those skilled in the art that any block diagrams herein represent conceptual views of illustrative systems. Similarly, it should be appreciated that any flow charts, flow diagrams, state transition diagrams, pseudo code, and the like represent various processes, which may be substantially represented in a computer readable medium and executed by a computer or processor, whether or not such computer or processor is explicitly shown.

### DETAILED DESCRIPTION

As memory technology has advanced, data storage capacity for electronic data storage devices, such as hard disk drives, has significantly increased, while the costs associated with such devices has decreased. Because of these factors, various entities, such as businesses and industry/market analysts, have started collecting and storing large amounts of data. These entities use these large data repositories for a variety of purposes, such as market analytics, forecasting, and the like. As an example, banks and financial institutions maintain large databases of financial and economic data, which may be used to perform CCAR stress testing,

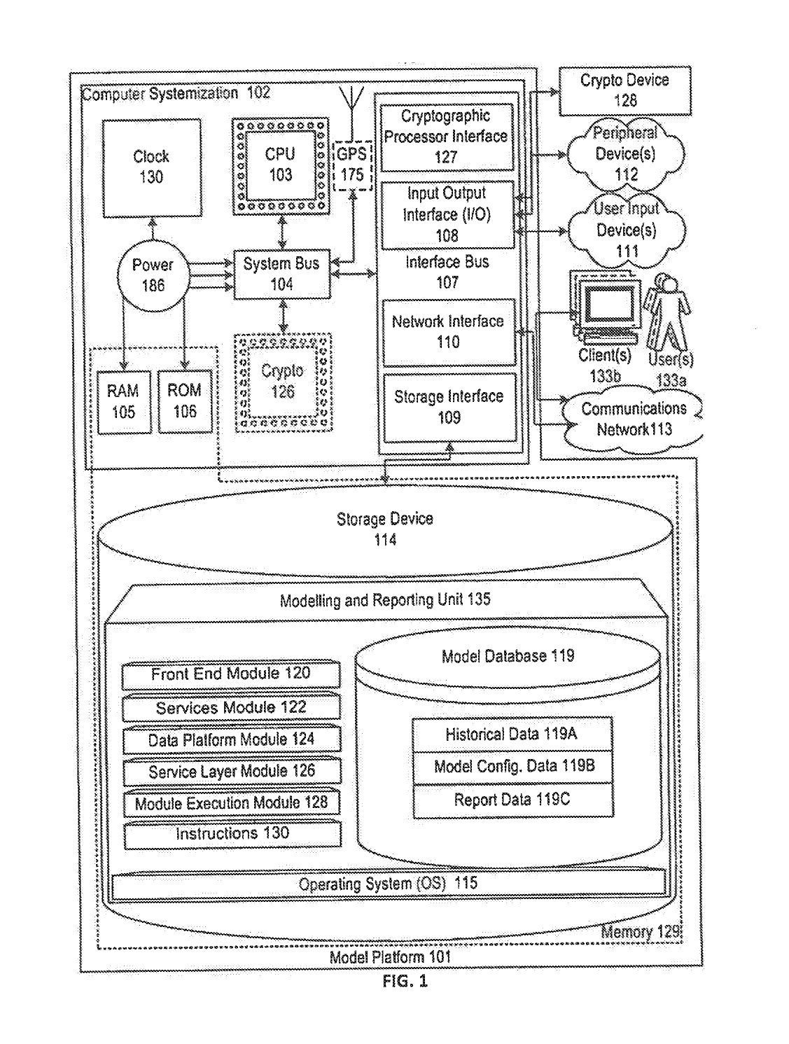

Referring to FIG. 1, a block diagram illustrating exemplary aspects of a model execution platform in. accordance with embodiments of the present disclosure is shown as a model execution platform 102. As shown in FIG. 1, a system according to embodiments of the present disclosure may include a model execution platform 102. In aspects, the model execution platform 102 may serve to: 1) compile, validate, and manage data sets; 2) generate models and execute the models based at least in part on the managed data sets; and 3) provide auditing and reporting capabilities with respect to execution of one or more models in accordance with aspects of the present disclosure, as described below with reference to FIGS. 1-3. In aspects, the model execution platform 102 may employ processors to process the input data (e.g., compile, validate and manage data sets and perform other operations in accordance with aspects of embodiments); such processors 103 may be referred to as central processing units (CPU). One form of processor is referred to as a microprocessor. CPUs use communicative circuits to pass binary encoded signals acting as instructions (e.g., instructions 132) to enable various operations. These instructions may be operational and/or data instructions containing and/or referencing other instructions and data in various processor accessible and operable areas of memory 129 (e.g., registers, cache memory, random access memory, etc.). Such communicative instructions may be stored and/or transmitted in batches (e.g., batches of instructions) as programs and/or data components to facilitate desired operations. These stored instruction codes (e.g., programs), may engage the CPU circuit components and other motherboard and/or system components to perform desired operations. One type of program is a computer operating system, which, may be executed by a CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the model execution platform 101 may be connected to and/or communicate with entities such as, but not limited to: one or more users 133a from user input devices 111; peripheral devices 112; an optical cryptographic processor device 125; and/or a communications network 113.

Networks are commonly thought to comprise the interconnection and interoperation of clients, servers, and intermediary nodes in a graph topology. It should be noted that the term “server” as used throughout this application refers generally to a computer, other device, program, or combination thereof that processes and respond to the requests of remote users across a communications network. Servers serve their information to requesting “clients,” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasks with furthering the passage of information from a source to a destination is commonly called a “router.” There are many forms of networks such as Local Area Networks (LANs), Pico networks, Wide Area. Networks (WANs), Wireless Networks (WLANs), etc. For example, the Internet is generally accepted as being an interconnection of a multitude of networks whereby remote clients and servers may access and interoperate with one another.

The model execution platform 101 may be based on computer systems that may comprise, tut are not limited to, components such as: a computer systemization 102 connected to memory 129.

### Computer Systemization

A computer systemization 102 may comprise a clock 130, central processing unit (“CPU(s)” and/or “processor(s)” (these terms are used interchangeably throughout the disclosure unless noted to the contrary)) 103, a memory 129 (e.g., a read only memory (ROM) 106, a random access memory (RAM) 105, etc.), and/or an interface bus 107, and most frequently, although not necessarily, are all interconnected and/or communicating through a system bus 104 on one or more (mother)board(s) 102 having conductive and/or otherwise transportive circuit pathways through which instructions (e.g., binary encoded signals) may travel to effectuate communications, operations, storage, etc. The computer systemization may be connected to a power source 186; e.g., optionally the power source may be internal. Optionally, a cryptographic processor 126 and/or transceivers (e.g., ICs) (not shown in FIG. 1) may be connected to the system bus. In another embodiment, the cryptographic processor and/or transceivers may be connected as either internal and/or external peripheral devices 112 via the interface bus I/O. In turn, the transceivers may be connected to antenna(s) 175, thereby effectuating wireless transmission and reception of various communication and/or sensor protocols, for example the antenna(s) may connect to: a Texas Instrument WiLink WL1283 transceiver chip (e.g., providing 802.11n, Bluetooth 3.0, FM, global positioning system (GPS) (thereby allowing location determinations)); Broadcom BCM4329FKUBG transceiver chip (e.g., GPS); an Infineon Technologies X-Gold 618-PMB9800 (e.g., providing 2G/3G HSDPA/HSUPA communications); and/or the like. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signal embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. It should be understood that in alternative embodiments, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory 129 beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory stage. The CPU may be a microprocessor such as: AMD's Athlon, Duron and/or Opteron; ARM's application, embedded and secure processors; IBM and/or Motorola's DragonBall and PowerPC; IBM's and Sony's Cell processor; Intel's Celeron, Core (2) Duo, Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the model execution platform 101 and beyond through various interfaces. Should processing requirements dictate a greater amount of speed and/or capacity, distributed processors (e.g., a distributed modelling platform), mainframe, multi-core, parallel, and/or super-computer architectures may similarly be employed. Alternatively, should deployment requirements dictate greater portability, smaller Personal Digital Assistants (PDAs), laptop computing devices, or other portable devices configured in accordance with embodiments of the present disclosure may be employed.

Depending on the particular implementation, features of the model execution platform 101 may be achieved by implementing a microcontroller such as CAST's R8051XC2 microcontroller; MCS 51 (i.e., 8051 microcontroller); and/or the like. Also, to implement certain features of the model execution platform 101, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the modelling platform component collection (distributed or otherwise) and/or features may be implemented via the microprocessor and/or via embedded components; e.g., via ASIC, coprocessor, DSP, FPGA, and/or the like. Alternately, some implementations of the modelling platform may be implemented with embedded components that are configured and used to achieve a variety of features or signal processing.

Depending on the particular implementation, the embedded components may include software solutions, hardware solutions, and/or some combination of both hardware/software solutions. For example, modelling platform features discussed herein may be achieved through implementing FPGAs, which are semiconductor devices containing programmable logic components called “logic blocks,” and programmable interconnects, such as the high performance FPGA Virtex series and/or the low cost Spartan series manufactured by Xilinx, Logic blocks and interconnects can be programmed by the customer or designer, after the FPGA is manufactured, to implement any of the features of the model execution platform 101. A hierarchy of programmable interconnects allow logic blocks to be interconnected as needed by the modelling platform system designer/administrator, somewhat like a one-chip programmable breadboard. An FPGA's logic blocks can be programmed to perform the operation of basic logic gates such as AND, and XOR, or more complex combinational operators such as decoders or mathematical operations. In most FPGAs, the logic blocks also include memory elements, which may be circuit flip-flops or more complete blocks of memory. In some circumstances, the modelling platform may be developed on regular FPGAs and then migrated onto a fixed version that more resembles ASIC implementations. Alternate or coordinating implementations may migrate modelling platform features to a final ASIC instead of or in addition to FPGAs. Depending on the implementation, all of the aforementioned embedded components and microprocessors may be considered the “CPU” and/or “processor” for the modelling platform.

### Power Source

The power source may be of any standard form for powering small electronic circuit board. devices such as the following power cells: alkaline, lithium hydride, lithium ion, lithium polymer, nickel cadmium, soar cells, and/or the like. Other types of AC or DC power sources may be used as well. In the case of solar cells, in one embodiment, the case provides an aperture through which the solar cell may capture photonic energy. The power cell is connected to at least one of the interconnected subsequent components of the modelling platform thereby providing an electric current to all subsequent components. In one example, the power source is connected to the system bus component 104. In an alternative embodiment, an outside power source is provided through a connection across the I/O 108 interface. For example, a USB and/or IEEE 1394 connection carries both data and power across the connection and is therefore a suitable source of power.

### Interface Adapters

Interface bus(es) 107 may accept, connect, and/or communicate to a number of interface adapters, conventionally although not necessarily in the form of adapter cards, such as but not limited to: input output interfaces (I/O) 1_____, storage interfaces 109, network interfaces 110, and/or the like. Optionally, cryptographic processor interfaces 127 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X), PCI Express, Personal Computer Memory Card International Association (PCMCIA), and/or the like.

Storage interfaces 109 may accept, communication, and/or connect to a number of storage devices such as, but not limited to: storage devices 114, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 110 may accept, communicate, and/or connect to a communications network 113. Through a communications network 113, the model execution platform 101 is accessible through remote clients 133b (e.g., computers and other electronic devices capable of generating and/or communicating data and other content to the modelling platform via a local or network-based connection) by users 133a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount of speed and/or capacity, distributed network controllers (e.g., distributed modelling platform), architectures may similarly be employed to pool, load balance, and/or otherwise increase the communicative bandwidth required by the modelling platform. A communications network may be any one and/or the combinations of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP, I-mode, and/or the like); and/or the like. A network interface may be regarded as a specialized form of an input output interface. Further, multiple network interfaces 110 may be used to engage with various communications network 113 types. For example, multiple network interfaces may be employed to allow for the communication over broadcast, multicast, and/or unicast networks.

Input Output interfaces (I/O) 108 may accept, communicate, and/or connect to user input devices 111, peripheral devices 112, cryptographic processor devices 125, and/or the like. I/O may employ connection protocols such as, but not limited to: audio: analog, digital, monaural, RCA, stereo, and/or the like; data: Apple Desktop Bus (ADB), IEEE 1394a-b, serial universal serial bus (USB); infrared; joystick; keyboard; midi; optical; PC AT; PS/2; parallel; radio; video interface: Apple, Desktop Connector (ADC), BNC, coaxial, component, composite, digital, Digital Visual Interface (DVI), high-definition multimedia interface (HDMI), RCA, RF antennae, S-Video, VGA, and/or the like; wireless transceivers: 802.11a/b/g/n/x; Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.); and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA. composite video cable; a DVI connector accepting a DVI display cable, etc.)

User input devices 111 often are a type of peripheral device 112 (see below) and may include: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like,

Peripheral devices 112 may be connected and/or communicate to I/O and/or other facilities of the like such as network interfaces, storage interfaces, directly to the interface bus, system bus, the CPU, and/or the like. Peripheral devices may be external, internal and/or part of the modelling platform. Peripheral devices may include: antenna, audio devices (e.g., line-in, line-out, microphone input, speakers, etc.), cameras (e.g., still, video, webcam, etc.), dongles (e.g., for copy protection, ensuring secure transactions with a digital signature, and/or the like), external processors (for added capabilities; e.g., crypto devices 125), force-feedback devices (e.g., vibrating motors), network interfaces, printers, scanners, storage devices, transceivers (e.g., cellular, GPS, etc.), video devices (e.g., goggles, monitors, etc.), video sources, visors, and/or the like. Peripheral devices often include types of input devices (e.g., cameras).

It should be noted that although user input devices and peripheral devices may be employed, the modelling platform may be embodied as an embedded, dedicated, and/or monitor-less (i.e., headless) device, wherein access would be provided over a network interface connection.

Cryptographic units such as, but not limited to, microcontrollers, processors 126, interfaces 127, and/or devices 125 may be attached, and/or communicate with the modelling platform. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of the CPU. Equivalent microcontrollers and/or processors may also be used. Other commercially available specialized cryptographic processors include: Broadcom's CryptoNetX and other Security Processors; nCipher's nShield; SafeNet's Luna PCI (e.g., 7100) series; Semaphore Communications' 40 MHz Roadrunner 184; Sun's Cryptographic Accelerators (e.g., Accelerator 6000 PCie Board, Accelerator 500 Daughtercard); Via Nano Processor (e.g., L2100, L2200, U2400) line, which is capable of performing 500+ MB/s of cryptographic instructions; VLSI Technology's 33 MHz 6868; and/or the like.

### Memory

Generally, any mechanization and/or embodiment allowing a processor to affect the storage and/or retrieval of information is regarded as memory 129. However, memory is a fungible technology and resource, thus, any number of memory embodiments may be employed in lieu of or in concert with one another. It is to be understood that the modelling platform and/or a computer systemization may employ various forms of memory 129. For example, a computer systemization may be configured wherein the operation of on-chip CPU memory (e.g., registers), RAM, ROM, and any other storage devices are provided by a paper punch tape or paper punch card mechanism; however, such an embodiment would result in an extremely slow rate of operation. In a typical configuration, memory 129 may include RC:)M 106, RAM 105, and a storage device 114. A storage device 114 may be any conventional computer system storage. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVDR/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

### Component Collection

The memory 129 may contain a collection of program and/or database components and/or data such as, but not limited to: operating system component(s) 115 (operating system); information server component(s) (information server); user interface component(s) (user interface); Web browser component(s) (Web browser); modelling database(s) 119; front end module 120; services module 122; data platform module 124; services layer module 126; model execution module 128; the modelling and reporting unit 135; and/or the like (i.e., collectively a component collection).

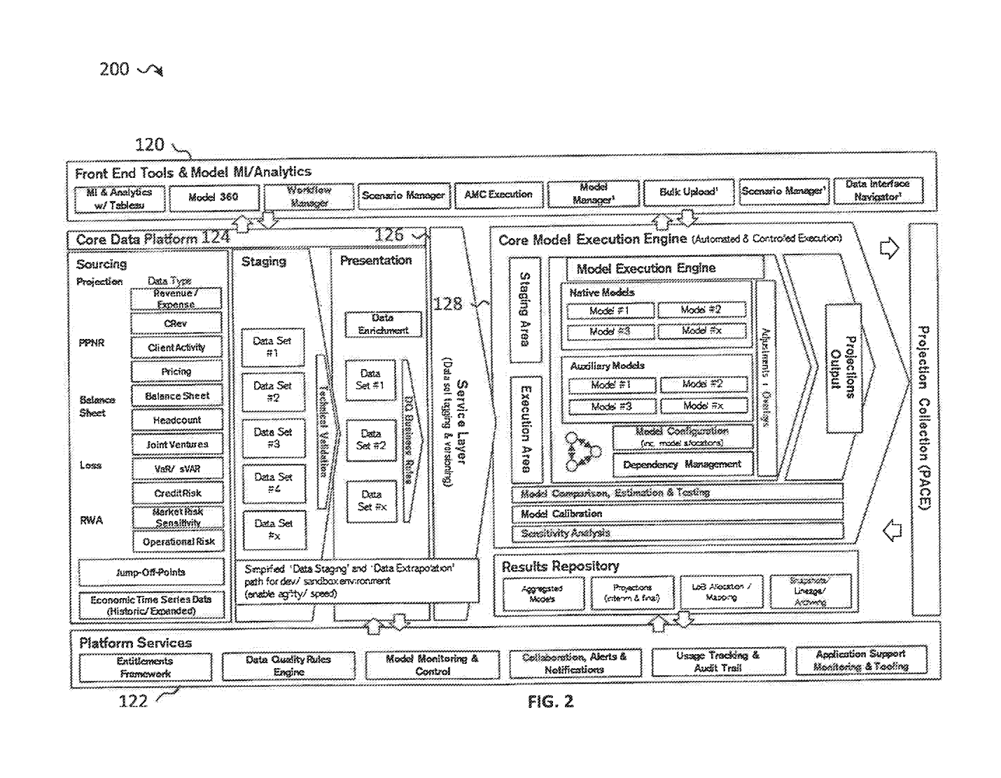

Referring to FIG. 2, a diagram illustrating aspects of operations for providing a modelling platform in accordance with embodiments of the present disclosure is shown as a modelling platform architecture 200. In aspects, the modelling platform architecture 200 may facilitate various modelling operations that may assist an entity, such as a business, in making decisions with respect to the entity's future operations. For example, a business may use modelling techniques to make forecasts or predictions about the business's future operational state, or conditions of one or more markets that the business serves or is served by. These forecasts may then be used by various personnel of the business to make decisions about how the operations of the business should be controlled, such as increasing production capacity if the modelling process indicates a surge in demand for products that the business produces, or reducing production of a product if the modelling process predicts a decrease in demand for the product over a period of time.

In addition to using modelling techniques to make forecasts or predictions about business operations, some entities use modelling techniques to respond to, and comply with, government regulations. For example, Basel Committee of Banking Supervision (BCBS) 239 is a governmental regulation that certain banks, known as Globally Systemically important Banks (G-SIBs), must comply with. BCBS 239 demands that the information banks use to drive decision making captures all risks with appropriate accuracy and timeliness. By setting out overarching principles of effective risk management reporting and governance. BCBS 239 focuses banks on developing the right capabilities to perform, among other types of testing, stress testing exercises, such as CCAR testing in the United States, and FDSF testing in the United Kingdom. The results of these tests must be provided to the appropriate regulatory authorities for review. Currently available techniques for performing these types of testing require users to manually input data into a spreadsheet that is designed to model one or more aspects of the test, and multiple different spreadsheets/models may be required to complete the necessary testing. The performance of these tests requires large amounts of data to be provide as inputs to the spreadsheets/models, and the manual techniques currently employed are error prone and time consuming. Some modelling tools have been developed to perform parts of the modelling that these types of tests require but these tools are typically provided in a piece-meal fashion where each tool is provided as a standalone tool and is not integrated with or designed to work with other tools. Thus, even with existing tools, some manual modelling using spreadsheets is usually required. Additionally, due to their standalone nature, outputs generated from existing tools may need to be manually provided (e.g., as inputs) to other models and tools.

Presently, implementing a CCAR or another type of test to which the principles outlined under BCBS 239 are designed to improve may take several weeks to complete and entities are often given a short amount of time (e.g., a month) to complete the analysis. Because of the length of time required to perform this type of modelling using existing tools and techniques, if an error is discovered, either in the underlying data used for the modelling process, or within the models used, there may not be sufficient time to correct the error and re-perform the analysis. As a result, many entities may be forced to submit inaccurate reports. Modelling platforms according to embodiments solve many or all of the problems associated with the above-described modelling and analysis techniques,

As shown in FIG. 2, a modelling platform architecture 200 of embodiments may include the front end module 120, the services module 122, the data platform module 124, the services layer module 126, and the model execution module 128 of FIG. 1. In aspects, each of the modules 120-128 may be implemented as instructions that, when executed by one or more processors, cause the one or more processors to perform operations for providing one or more aspects of a modelling platform in accordance with embodiments. In some aspects, one or more of the modules 120-128 may be implemented. in hardware, rather than software (e.g., instructions executed by a processor), or may be implemented as a combination of hardware and software,

In aspects, the front end module 120 may be configured to provide one or more graphical user interfaces (GUIs) that enable users, such as users 133a of FIG. 1, to interact with the modelling platform. For example, the one or more GUIs may include an interactive tool that enables a user to create one or more models. In aspects, during creation of a model, a user may provide model configuration data that specifies various attributes of the model that is being created. For example, the model configuration data may include parameters that identify other models that are dependent upon model that is being created and/or parameters that identify models upon which the model that is being created depends.

Testing performed under BCBS 239-type regulations is often based on scenarios provided by the regulatory authority, and in some aspects, the creation of a model using the interactive tools provided by the front end module 120 may be based on the provided scenario. For example, the scenario may require G-SIBs to report what the economic impact of a hypothetical real world event (e.g., Brexit, a nuclear attack, etc.) would be, and the user may configure a model to reflect the specified scenario. In aspects, the model may be constructed by specifying relationships between various models (e.g., stored as the modelling data 119B or other third party models) that are accessible to the modelling platform. By enabling the user to configure a model of a specified scenario using a library of existing models, the model may be generated more quickly.

In addition to providing interactive tools for creation of models, the front end module 120 may be configured to present other GUIs to the user. For example, the front end module 120 may be configured to enable users to view and modify data, such as data compiled by the data platform module 124, or perform other operations to view aspects of the modelling platform (e.g., workflow management, model management, scenario management, and the like).

The services module 122 may provide a plurality of services that interact with various other modules to facilitate portions of the operations provided by the modelling platform. For example, the services module 122 may provide a data quality rules engine, usage tracking and auditing, and other functionality to support the operations of the modelling platform. In aspects, the data quality rules engine of the services module may be configured to manage data sets used to execute various ones of the models utilized by the modelling platform. For example, when performing modelling under BCBS 239-type scenarios, it is important that the data sets be it for their intended purpose (e.g., accurate for the particular testing being performed). Often, the data may change over time and users may be periodically required to attest to the fitness of the data used for such testing and analysis. In aspects, the data quality rules engine may provide various GUIs that support the verification of the data sets managed and maintained by the modelling platform. For example, in aspects, each of the data sets may be associated with validation information (e.g., created using the data quality rules engine). For a particular data set of the plurality of data sets, the validation information may include modelling criteria that may be used to determine Whether the particular data set has been authorized for, or is suitable for, use as an input data set during execution of one or more models of the plurality of models. In aspects, a data set may be authorized for use with one model, but not other models. This may occur when the data set is not accurate for one model, but is accurate for another model (e.g., because the different models utilize different portions of the data set). in some aspects, a data set may be required to be authorized for all models before it may be used to execute any models. It is noted that the particular types of authorizations for data sets in connection with their use to execute models has been provided for purposes of illustration, rather than by way of limitation, and that other types of authorization designations may be provided, implemented, or used by the data quality rules engine of the services module.

The usage tracking and auditing trail service may facilitate functionality for logging, authenticating, and auditing use of the modelling platform. For example, as explained above, the data sets used to execute the models may be subject to periodic changes. If the data used to execute the models at first point in time changes, the result of the model execution may also change. For BOBS 239-type testing, it is important to be able to justify or explain any changes in the results. In aspects, the usage tracking and auditing trail service may be configured to facilitate operations to prove up prior executions of a set of models despite changes in the underlying data. For example, the usage tracking and auditing trail service may be configured to create a database record representative of the model execution parameters utilized to execute the set of models and store the database record in a database accessible to the modelling platform (e.g., as an entry in report data 119C of FIG. 1). The model execution parameters may identify the set of models that were executed to produce a particular result of BCBS 239-type. testing, the data set(s) that were provided as inputs to the set of models, the state of the data sets (e.g., a snapshot of the data set at the time the set of models were executed), a sequence or order in which the set of models were executed, and the like.

The usage tracking and auditing trail service may be configured to detect alterations of portions of the data included in the plurality of data sets, and in response to detecting the alteration, may create a change record identifying the alterations of the data. In aspects, this may include capturing a snapshot of the data prior to its alteration. In some aspects, the snapshot may be a physical copy of the data prior to its alteration. In some aspects, the snapshot may not be a physical copy of the data prior to its alteration and may instead, merely be indicative of the state of the data prior to the alteration. For example, if a data point has a previous value of $21,356,577.98, and this value was subsequently altered to $21,356,576.98, the change record may identify the data record and/or data point that was altered, indicate a particular time corresponding to the alteration, and include information indicative of the alteration, such as indicating that the value prior to the alteration was $1 less than the value after the alteration in the example above. It is noted that the exemplary change record and alteration described above has been provided for purposes of illustration, rather than by way of limitation and that a modelling execution platform configured in accordance with. aspects of the modelling execution platform architecture illustrated in FIG. 2 may be configured to account for other types of alterations and changes to data sets utilized to perform modelling operations. In aspects, the change records may be stored at the database (e.g., as a record in historical data 119A and/or report data 119C).

In aspects, the database records and change records may be timestamped. This may facilitate re-execution of a set of models to prove up or validate a prior execution of the set of models after an alteration of the data used during the prior execution. For example, if a set of models is executed on a set(s) of data and the result of that execution is reported (e.g., to a government or regulatory authority) and the set(s) of data change, re-executing the set of models using the changed data set(s) may produce a different result. To avoid such occurrences, the database records and the changes records may be used to demonstrate the data sets used during the prior execution were accurate at the time. For example, the change records may be utilized to reconstruct the data set(s) as those data sets existed prior to the change(s), and the reconstructed data set(s) may be utilized to re-execute the set of models, thereby recreating the results produced during the initial execution of the models. Additionally, a subsequent execution of the set of models on the altered data set may be performed, which may produce results that demonstrate the models and altered data set provides a more accurate result that was previously not available (e.g., because the available data sets were different). As shown above, the execution of models by the modelling platform of embodiments may be deterministic (e.g., previous results can be consistently reproduced) despite alterations of the underlying data over time. Additionally, tracking and logging the changes to the data set(s) reduces the data storage requirements of the system (e.g., because entire data set(s) do not have to be duplicated every time that there is a change).

The data platform module 124 may compile a plurality of data sets, which may be used as inputs during execution of one or more models, in aspects, the data platform module 124 may provide staging of the data sets during execution of the set of models and the service layer module 126 may be configured to interface the data platform module with various other aspects of the modelling platform, such as the model execution platform 128. The service module 122 may provide other services, such as alert services, notification services, monitoring and support services, and the like.

The model execution platform 128 may be configured to determine model execution parameters for executing a set of models selected from among a plurality of models accessible to the modelling platform. In aspects, the plurality of models may include models stored at a database of the modelling platform, such as models stored as model data 119B. The plurality of models accessible to the modelling platform one or more models hosted by the modelling platform and third party models accessible to the modelling platform via a network communication link. For example, the modelling platform may be configured to integrate with one or more third party models (e.g., to provide an input to the third party model, receive an output from the third party model, or both). By configuring the modelling platform to include local models and providing integration capabilities with respect to third party models, the modelling platform of embodiments provides a comprehensive modelling solution that may eliminate the need to implement manual integration of models and modelling data. In aspects, the model execution parameters may identify one or more data sets of the plurality of data sets that are to be provided as inputs during execution of each model included in the set of models. Additionally, the model execution parameters may identify an execution order for the set of models. As briefly described above, the execution order may identify dependencies between the models included in the set of models, where a dependency between a first model and a second model indicates that an output of the first model is to be provided as an input during execution of the second model. It is noted that the output of the first model may be just one of many inputs to the second model. For example, the output of the first model may be a first parameter or data set used to execute the second model, and the second model may receive, as one or more additional inputs, information from other models and/or one or more data sets upon which the second model is executed. Thus, in aspects, models may have multiple dependencies including dependencies based on outputs of multiple models) and input parameters.

In aspects, the model execution platform 128 may be configured to automatically execute the set of models in accordance with the execution order to produce an output metric that represents a cumulative result of execution of the set of models. For example, as explained above, the set of models may be configured to represent a real world scenario, which may be specified by a regulatory authority or may be defined based on internal gals of the entity performing the modelling (e.g., as a quality control monitoring or self-evaluation process). The scenario may be distilled into a model that receives, as inputs, outputs of various other models, each of which may represent one factor or variable within the scenario modelling process. In aspects, the output metric may be represented as a single value. In some aspects, the output metric may be represented as multiple values. For example, the scenario may dictate a simple outcome (e.g., would a bank have enough liquidity to handle a run on the bank's cash reserves following an event) for which a single value (e.g., yes or no) would suffice. However, in some instances, the scenario may dictate a more complex outcome that requires multiple factors to be accounted for, such as how would the occurrence of a particular natural disaster impact various industry sectors (e.g., manufacturing, telecommunications, entertainment, etc.), In such a scenario, the outcome metric may include multiple factors or metrics that represent the various affected industry sectors, such as supply and demand of materials used to manufacture goods; supply and demand of for manufactured goods; areas affected by telecommunications infrastructure failures; disruption of telecommunication services; and other possible predictions and outcomes. it is noted that the particular scenarios described above, and the corresponding output metrics, have been provided for purposes of illustration, rather than by way of limitation.

In aspects, the model execution platform 128 may be configured to generate one or more reports that indicate the impact that a real world occurrence of the event(s) associated with the scenario would have. in aspects, the model execution platform 128 may also be configured to determine one or more measures to counteract the impact the real world event would have if the modelled scenario occurred and the one or more measures may be included in the report. In some aspects, one or more countermeasure models may be used to analyze possible ways in which to improve the outcome metric(s) obtained during the execution of the set of models, and these models may receive the output metric as an input. For example, a first modelling phase may be executed to determine the predicted outcome of a particular scenario, and the predicted outcome of the first modelling phase may be provided as an input to a second modelled phase executed to determine one or more measures to counteract predicted outcome of the scenario modelled during the first modelling phase. In some aspects, this information may be provided by a user. The report(s) may be stored as an entry in the report data 1190.

As shown above, the modelling platform of embodiments is configured to improve the way in which models are executed. In many of the types of testing for which use of the modelling platform is contemplated, such as BCBS 239-type modelling, a set of models to be executed in a single run may involve 100 or more models and extremely large data sets. Presently available tools for such modelling purposes would require weeks to complete. However, the modelling platform of embodiments is capable of completing such tests in as little as 30 minutes. This allows many different models to be evaluated in a fraction of the time of traditional techniques. Thus, if an error is detected halfway through a time period allocated for preparing reports to a governmental or regulatory authority, the modelling platform of embodiments is capable of being reconfigured and rerun without risking missing the reporting deadline. Additionally, because the modelling platform is configured to provide deterministic model execution despite changes in data sets over time, results of testing/modelling using the modelling platform of embodiments may increase the credibility of the reports that are generated e.g., because they can be audited and validated for any execution of the set of models). As shown above, the modelling platform of embodiments provides an improved system for performing complex modelling, such as BCBS 239 type modelling. Additionally, it is noted that although primarily described with respect to BCBS 239-type testing, modelling platforms configured according to embodiments may be readily utilized to perform modelling and testing other than BCBS 239-type testing. Additional aspects of the modelling platform architecture 200 illustrated in FIG. 2 are described below.

Referring back to FIG. 1, the above-described components of the model execution platform 101 may be stored and accessed from the storage devices and/or from storage devices accessible through an interface bus. Although non-conventional program components such as those in the component collection, typically, are stored in a local storage device 114, they may also be loaded and/or stored in memory such as: peripheral devices, RAM, remote storage facilities through a communications network, ROM, various forms of memory, and/or the like,

### Operating System

The operating system component 115 is an executable program component facilitating the operation of the modelling platform. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Plan 9; Be OS; Unix and. Unix-like system. distributions (such as AT&T's UNIX; Berkley Software Distribution (BSD) variations such as FreeBSD, NetBSD, OpenBSi), and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millenium/NT/Vista/XP (Server), Palm OS, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the modelling platform to communicate with other entities through a communications network 113. Various communication protocols may be used by the modelling platform as a subcarrier transport mechanism for interaction, such as, but not limited to: multicast, TCP/IP, IMP, unicast, and/or the like.

### Information Server

An information server component 116 is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), .ActiveX, (ANSI) (Objective-) C (++), C# and/or .NET, Common Gateway Interface (CGI) scripts, dynamic (ID) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText.

Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the modelling platform based on the remainder of the HITT request. For example, a request such as http:/1123,124,125,126/myinformation.html might have the IP portion of the request “123.124.125.126” resolved by a DNS server to an information server at that IP address; that information server might in turn further parse the http request for the “/myinformation.html” portion of the request and resolve it to a location in memory containing the information “myinformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the modelling database 119, operating systems, other program components, user interfaces, Web browsers, and/ or the like.

Access to the modelling database 119 may be achieved through a number of database bridge mechanisms such as through scripting languages as enumerated below (e.g., CGI) and through hater-application communication channels as enumerated below (e.g., CORBA, WebObjects, etc.). Any data requests through a Web browser are parsed through the bridge mechanism into appropriate grammars as required by the modelling platform, in one embodiment, the information server would provide a Web form accessible by a Web browser, Entries made into supplied fields in the Web form are tagged as having been entered into the particular fields, and parsed as such. The entered items are then passed along with the field tags, which act to instruct the parser to generate queries directed to appropriate tables and/or fields, in one embodiment, the parser may generate queries in standard SQL by instantiating a search string with the proper join/select commands based on the tagged text entries, wherein the resulting command is provided over the bridge mechanism to the modelling platform as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millenium/NT/XP/Vista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component (not shown in FIG. 1) is a stored program component that is executed by a CPU. The user interface may be a graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component (not shown in FIG. 1) is a stored program component that is executed by a CPU. The Web browser may be a hypertext viewing application such as Microsoft Internet Explorer or Netscape Navigator. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APis FireFox, Safari Plug-in, and/or the like APis), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Also, in place of a Web browser and information server, a combined application may be developed to perform similar operations of both. The combined application would similarly affect the obtaining and the provision of information to users, user agents, and/or the like from the modelling platform enabled nodes. The combined application may be nugatory on systems employing standard Web browsers.

### The Modelling Database

The modelling database component 119 may be embodied in a database and its stored data. The database is a stored program component, which is executed by the CPU; the stored program component portion configuring the CPU to process the stored data. The database may be a fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the modelling database 119 may be implemented using various other data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of capabilities encapsulated within a given object. If the modelling database 119 is implemented as a data-structure, the use of the modelling database 119 may be integrated into another component such as the modelling and reporting unit 135. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

As described above, the modelling database component 119 includes historical data 119A, model configuration data 119B, and report data 1190. In one embodiment, the historical data 119A may include historical data compiled by the modelling platform during operations of an entity, such as historical records of transactions of a business, and/or may be obtained from, or generated by users 133a, and/or the like. In an aspect, the historical data 119A may also include change data, such as information that specifies different data values corresponding to different points in time or information that indicates changes to stored data values over time, as described above. Additionally or alternatively, the change data may be stored as model configuration data 119B, such as to specify the state of data utilized for a particular execution of a model execution phase. The modelling configuration data 119B may include one or more models, such as the models described above with respect to FIG. 2, that may be executed on a data set selected from among the historical data 119A. In aspects, the modelling configuration data 119B may also include information that may be used to determine an order in which a set of models should be executed. As described above, as a result execution of the set of models, one or more reports may be generated, which may be stored at the modelling database 119 as the report data 1190.

In one embodiment, the modelling database 119 may interact with other database systems. For example, employing a distributed database system, queries and data access may be facilitated by a search component, which may treat the combination of the modelling database 119 and other databases as a single database entity.

In one embodiment, user programs may contain various user interface primitives, which may serve to update the model execution platform 101. Also, various accounts may require custom database tables depending upon the environments and the types of clients the model execution platform 101 may need to serve. It should be noted that any unique fields may be designated as a key field throughout. In an embodiment, these tables may be decentralized into their own databases and their respective database controllers (i.e., individual database controllers for each of the above tables). Employing data processing techniques, one may further distribute the databases over several computer systemizations and/or storage devices. Similarly, configurations of the decentralized database controllers may be varied by consolidating and/or distributing the various database components 119A-C. in aspects, the model execution platform 101 may be configured to keep track of various settings, inputs, and parameters via database controllers.

The modelling database 119 may communicate to and/or with other components in a component collection, including itself, and/or facilities of the like. Most frequently, the modelling database 119 communicates with the modelling and reporting unit 135, other program components, and/or the like. The database may contain, retain, and provide information regarding other nodes and data.

### The Modelling and Reporting Unit

The modelling and reporting 135 may be a stored program component that is executed by a CPU. In one embodiment, the modelling and reporting 135 incorporates any and/or all combinations of the aspects of the modelling platform described herein. As such, the modelling and reporting unit 135 affects accessing, obtaining and the provision of information, services, transactions, and/or the like across various communications networks. The features and embodiments of the modelling and reporting unit 135 discussed herein increase network efficiency by reducing data transfer requirements the use of more efficient data structures and mechanisms for their transfer and storage. As a consequence, more data may be transferred in less time, and latencies with regard to transactions, are also reduced. In many cases, such reduction in storage, transfer time, bandwidth requirements, latencies, etc., will reduce the capacity and structural infrastructure requirements to support the modelling platform's features and facilities, and in many cases reduce the costs, energy consumption/requirements, and extend the life of modelling platform's underlying infrastructure; this has the added benefit of making the modelling platform more reliable. Similarly, many of the features and mechanisms are designed to be easier for users to use and access, thereby broadening the audience that may enjoy/employ and exploit the feature sets of the modelling platform; such ease of use also helps to increase the reliability of the modelling platform.

The modelling and reporting unit 135 may enable access of information between nodes by employing development tools and languages such as, but not limited to; Apache components, Assembly, ActiveX, binary executables, (ANSI) (Objective-) C (++), C# and/or NET, database adapters, CCI scripts, Java, JavaScript, mapping tools, procedural and object oriented development tools, PERL, PHP, Python, shell scripts, SQL commands, web application server extensions, web development environments and libraries (e.g., Microsoft's ActiveX; Adobe AIR, FLEX & FLASH; AJAX; (D)HTML; Dojo, Java; JavaScript; jQuery(UI) MooTools; Prototype; script.aculo.us; Simple Object Access Protocol (SOAP); SWFObject; Yahoo! User Interface; and/or the like), WebObjects, and/or the like. In one embodiment, the modelling platform server employs a cryptographic server to encrypt and decrypt communications. The modelling platform may communicate to and/or with other components in a component collection, including itself, and/or facilities of the like. Most frequently, the modelling platform communicates with the modelling database, operating systems, other program components, and/or the like. The mixing controller may contain, communicate, generate, obtain, and/or provide program component, system, user, and/or data communications, requests, and/or responses.

### Distributed Modelling Platforms

The structure and/or operation of any of the modelling platform components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the modelling platform I/O may depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), Jini local and remote application program interfaces, JavaScript Object Notation (JSON), Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using development tools such as lex, yacc, XML, and/or the like, which. allow for grammar generation and parsing capabilities, which in turn may form the basis of communication messages within and between components.

For example, a grammar may be arranged to recognize the tokens of an II TTP post command, e.g.:

w3c -post http:// . . . Value!
where Value 1 is discerned as being a parameter because “http:/f” is part of the grammar syntax, and what follows is considered part of the post value. Similarly, with such a grammar, a variable “Value!” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated and/or readily available parsers (e.g., JSON, SOAP, and/or like parsers) that may be employed to parse (e.g., communications) data. Further, the parsing grammar may be used beyond message parsing, but may also be used to parse: databases, data collections, data stores, structured data, and/or the like. Again, the desired configuration will depend upon the context, environment, and requirements of system deployment.

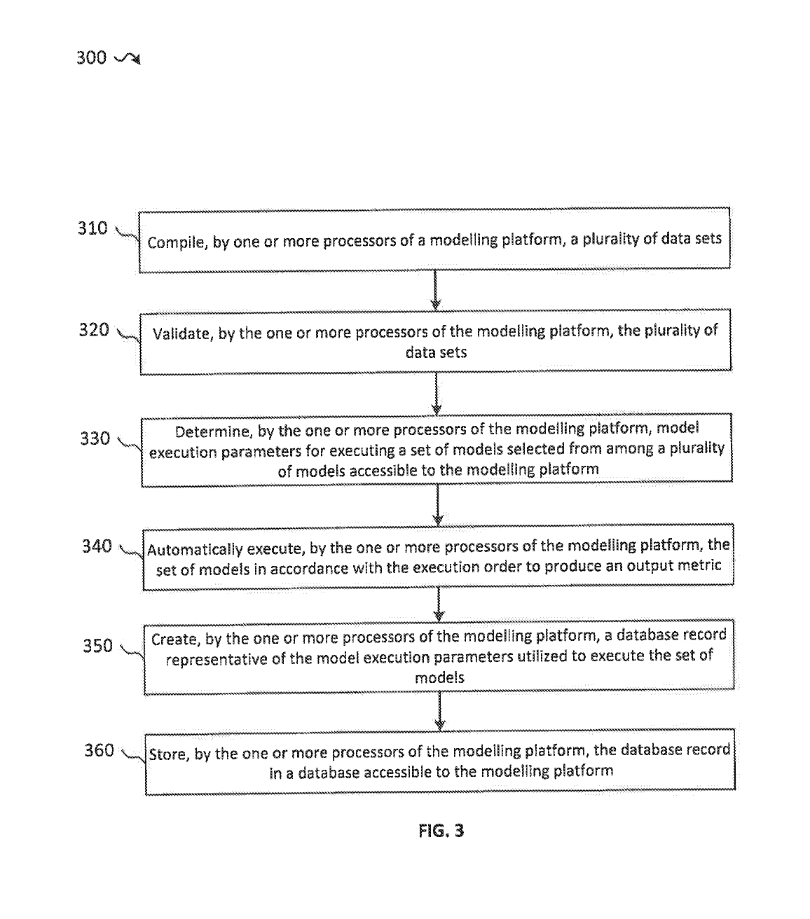

Referring to FIG. 3, a flow diagram of illustrating aspects of an exemplary method for providing a modelling platform in accordance with embodiments of the present disclosure is shown as a method 300, in aspects, the method 300 may be stored as instructions (e.g., the instructions 132 of FIG. 1) that, when executed by one or more processors, cause the one or more processors to perform the operations of a modelling platform, as described herein with reference to FIGS. 1 and 2.

As shown in FIG. 3, the method 300 may include, at 310, compiling, by one or more processors of a modelling platform, a plurality of data sets. In aspects, the plurality of data sets may be stored in a database as historical data sets (e.g., the historical data sets 119A). At 320, the method 300 includes validating, by the one or more processors of the modelling platform, the plurality of data sets, wherein the validating is configured to verify that each of the plurality of data sets satisfies one or more modelling criteria.

At 330, the method 300 includes determining, by the one or more processors of the modelling platform, model execution parameters for executing a set of models selected from among a plurality of models accessible to the modelling platform. In aspects, the model execution parameters may identify one or more data sets of the plurality of data sets that are to be provided as inputs during execution of each model included in the set of models. Additionally, the model execution parameters may identify an execution order for the set of models, where the execution order identifies dependencies between the models included in the set of models. As explained above with reference to FIG. 2, a dependency between a first model and a second model may indicate that an output of the first model is to be provided as an input during execution of the second model. By identifying dependencies between different models, the execution of each model may be configured to allow concurrent execution of some models (e.g., models that have no dependencies), and sequential execution of other models (e.g., models with dependencies must be executed only after all models that are to provide inputs have been executed). In this manner, the execution of the models may be completed more quickly and achieve a more accurate result, as described above with reference to FIG. 2.

At 340, the method 300 includes automatically executing, by the one or more processors of the modelling platform, the set of models in accordance with the execution order to produce an output metric. As explained above with reference to FIG. 2, the output metric may represent a can result of execution of the set of models. That is to say that execution of each model may individually generate an output, but the output metric represents the cumulative result of all outputs generated by execution of the set of models, as described above with reference to FIG. 2.

In aspects, the method 300 includes, at 350, creating, by the one or more processors of the modelling platform, a database record representative of the model execution parameters utilized to execute the set of models, and, at 360, storing, by the one or more processors of the modelling platform, the database record in a database accessible to the modelling platform. In aspects, the database record may be timestamped, as described above with reference to FIG. 2. In some aspects, the method 300 may also include generating timestamped change records, as described above with reference to FIG. 2.

As shown above, through providing a set of rules that enable a modelling platform to automatically execute a set of models according to embodiments, the modelling platform may execute a set of models more quickly and produce a more accurate result as compared to existing modelling technologies, which commonly rely on manual procedures, such as copying an pasting information into spreadsheet programs like Microsoft Excel® and/or using multiple non-integrated and/or incompatible modelling tools. Additionally, a modelling platform according to embodiments is configured to produce output metrics that are deterministic even when the underlying data that was originally used to execute the set of models has changed, Thus, as data changes more accurate output metrics may be obtained by executing the set of models on the altered data, but output metrics produced by executions of the set of models prior to the data alteration may be accurately reproduced, thereby allowing changes in the output metrics to be proved up (e.g., demonstrated as accurate at the time of execution of the set of models). Thus, the modelling platform of embodiments improves the speed at which one or more computers configured to implement a modelling platform operate to complete an execution of a set of models, produce more accurate model outputs, and operate in a deterministic manner despite changes to underlying data sets over time.

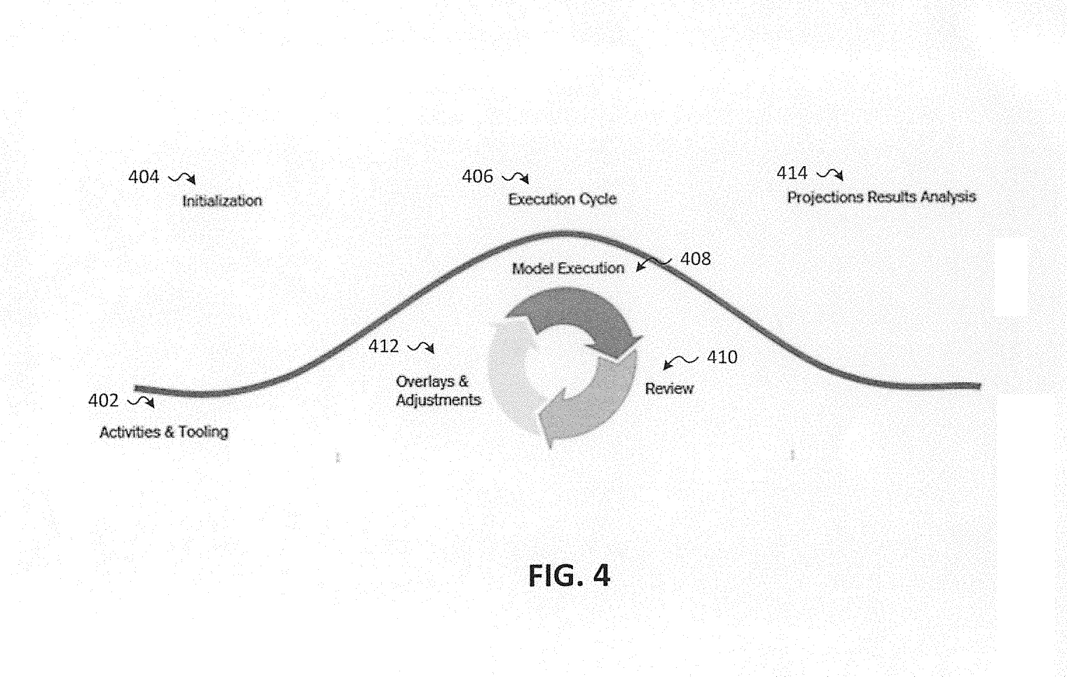

Referring to FIG. 4, a diagram illustrating aspects of a process for utilizing modelling platform in accordance with embodiments of the present disclosure is shown. In an aspect, the modelling process illustrated in FIG. 4 may be performed by a model execution platform (e.g., the model execution platform 101 of FIG. 1) having a modelling platform architecture (e.g., the modelling platform architecture 200 of FIG. 2) configured in accordance with aspects of the present disclosure. At activities and tooling step 402, data may be compiled for subsequent utilization in a modelling process. The compiled data may include information ingested from a plurality of data sources and may be utilized to construct one or more data sets that are provided as inputs to one or more models. In an aspect, at least a portion of the input data may be compiled during the ordinary course of an entity's operations. For example, when the entity is a financial institution, the input data may correspond to ingested information may correspond to transactions, investments, and other aspects of the financial institutions daily operations. In an aspect, the entity's daily operations information may include information that is irrelevant to model execution, such as customer names, account numbers, telephone numbers, etc. As explained below, any irrelevant information included in the compiled data may be excluded from the data sets utilized during model execution. The input data may be stored at a database (e.g., the modelling database 119 of FIG. 1) as historical data (e.g., the historical data 119A of FIG. 1).

In an aspect, the activities and tooling step 402 may also include creation of one or more models. For example, when new scenarios need to be evaluated, one or more new models may need to be designed. As explained above, a model execution platform in accordance with aspects of the present disclosure may provide one or more graphical user interfaces that facilitate creation of new models. In an aspect, a new model may be created, at least in part from one or more existing models, such as by changing one or more features of the model, changing the types and/or sources of input data used by the model, changing the types of outputs created during execution of the model, and the like. For example, a model that was previously designed to evaluate the impact of a natural disaster on a first industry may be modified to create a second model designed to evaluate the impact of a different natural disaster or event on the first industry or the impact of the natural disaster or another event on a second industry. The modification may involve modification of the inputs to the model, such as to change the input data sets utilized to execute the model and/or modifications to change one or more models upon which the new model depends or which depend on the newly created model.

After the activities and tooling step 402, an initialization step 404 may be performed. During the initialization step 404, various operations may be performed to initialize the one or more models for execution. Initialization of the one or more models may include normalization of the input information, such as to convert portions of data to a particular format, arrange data, eliminate data that is irrelevant to model execution, or other operations. In an aspect, initialization may also include selecting one or more models to be used during the modelling process and when multiple models are to be utilized, configuring dependencies between the models. Interactive tools provided by the one or more graphical user interfaces may he utilized to create metadata that maps a set of models to various sources of input data, establishes dependencies between models, and establishes an order of execution of the models corresponding to a particular scenario. The model(s) may be selected based on the particular testing to be performed. For example, a model execution platform, such as the model execution platform 101 of FIG. 1, which may have an architecture similar to the modelling platform architecture 200 illustrated ire FIG. 2, may maintain a database of models (e.g., the model configuration data 119B). To facilitate modelling operations for a particular scenario or purpose, one or more models may be selected from the database of models. In an aspect, the model execution platform (e.g., the front end module 120 of FIG. 1) may provide one or more graphical user interfaces that facilitate interactive selection of the models to be utilized. As described above, information associated with dependencies between the different models may also be stored in a database (e.g., as part of the model configuration data 119B), which may facilitate automatic configuration of dependencies between selected models.

In an aspect, the one or more graphical user interfaces may facilitate selection of models based on predefined scenarios. For example, the one or more graphical user interfaces may present a plurality of scenarios from which a single scenario may be selected. Upon selection of the scenario, one or more models configured to generate an output representative of the impact of the selected scenario may be identified for execution. In an aspect, despite being predefined, one or more characteristics of the selected scenario may be configurable. For example, if a scenario is associated with a particular event (e.g., a stock market crash, a nuclear attack, a natural disaster, etc.), details associated with the particular event may be customized, such as to define the location(s) of the event, the severity of the event (e.g., how far the stock market crashed, the population density of an area where the nuclear attack occurred, the damage caused by a natural disaster, etc.). In this manner, tasks associated with initialization of the particular scenario to be evaluated and the models to be executed during the modelling process to evaluate the particular scenario may be completed more rapidly.

Following initialization, at step 404, one or more model execution cycles 406 may be executed. In an aspect, each model execution cycle 406 may involve a model execution. phase 408, a review phase 410, and an overlays and adjustment phase 412. During the model execution phase 408, one or more models may be executed against the input data sets in accordance with the scenario(s) and parameters configured during the activities and tooling step 402 and the initialization operations performed at step 404. In an aspect, utilization of input data sets derived from historical data (e.g., the historical data 119A of FIG. 1) may be restricted to validated data sets. For example, during step 402, step 404, or at another point in time, data sets may be vetted to verify the accuracy of the data for a particular purpose, such as use with one or more particular models and/or scenarios. Information specifying the particular model(s) and/or scenario(s) for which a particular data set has been authorized may be utilized to control execution of the one or more models (e.g., during the model execution phase). For example, prior to initiating an execution cycle, the information specifying the particular model(s) and/or scenario(s) for which a particular data set has been authorized may be verified against the parameters utilized to configure a particular execution cycle of a set of models to ensure that the data sets utilized to execute the models are accurate for the relevant configuration of the model execution phase 408. If the data sets are not authorized for the particular configuration of the model execution phase 408, an alert may be generated. In an aspect, the data sets may be analyzed to determine whether an appropriate data that has been authorized for execution. exists. If an appropriate data set is identified, that data set may be utilized to execute the model execution phase 408 and an alert may be generated if an appropriate data set is not identified.

As a result of the model execution phase 408, one or more outputs may be generated. The one or more outputs may correspond to an outcome representative of a predicted response to the selected scenario(s). For example, where the scenario correspond to a particular event, such as a stock market crash, the outcome of the model execution phase 408 may correspond to a predicted response to the particular event, such as how that particular event will impact a financial institution's operations, liquidity, and the like. In an aspect, the predicted response may be representative of a period of time, such as how the particular event will impact the financial institutions operations, liquidity, and the like immediately following the particular event, as well as one or more additional time periods (e.g., 1 month after the particular event, 2 months after the particular event, etc. In an additional aspect, the predicted response may be representative of a particular instance in time, such as how the particular event will impact the financial institutions operations, liquidity, and the like immediately following the particular event or 3 months after the particular event (or another point in time).

To illustrate, for Capital Stress Testing (such as the CCAR as required by the Federal Reserve Bank) model outputs may represent key financial metrics (e.g., balance sheet projections, risk weighted assets, revenues, expenses, liabilities, losses, and the like) for various aspects of a business' operations, for a given economic scenario, on a forward looking basis. Aggregation of these components may provide insights into capital requirements for the given economic scenario. As another example, for Resolution and Recovery Planning (as required by regulators in multiple regions) model outputs may include capital and liquidity projections. Beyond the regulatory domain, model execution platforms according to aspects of the present disclosure may provide outputs representing other types of quantitatively derived projections, for example product recommendations—based on prior purchasing patterns and similarities to other clients.

In an aspect, the model execution phase 408 may execute a plurality of models. During execution of the plurality of models, dependencies between the plurality of models may be utilized to control an order in which the models are executed. For example, a first model may be dependent on outputs of a second model and a third model. Thus, during the model execution phase 408, a model execution engine (e.g., the model execution module 128 of FIG. 1) may execute the second model and the third model and then provide the outputs (or a portion of the outputs) generated in response to execution of the second and third models as inputs to the first model. If another model is dependent upon the first model, the output(s) (or a portion of the output(s)) of the first model may be provided as inputs to the other model. In an aspect, dependencies between the plurality of models may be configured during the initialization phase 404 and/or the activities and tooling phase 402.

Following the model execution phase 408, a review phase 410 may be conducted. During the review phase 410, the outputs generated during the model execution phase 408 may be analyzed to evaluate whether the modelling process is performing as expected. For example, the outputs of the model execution phase may be analyzed to identify weaknesses and/or limitations, if any, of the executed models. Additionally, during the review phase, analysis may be performed to verify that the models were executed utilizing the proper parameters and data sets, such as verifying the utilized data sets accounted for any appropriate changes to the data set contents. Another aspect of the model execution phase that may be evaluated during the review phase may be whether the model(s) reflect their intended purpose, such as to accurately characterize the relevant aspects of the operations evaluated by the model, and to verify that the models appropriately account for and/or quantify known risks. In an aspect, model outputs may by reviewed or analyzed by comparing the results to benchmark or challenger models, which may correspond to models developed or designed to follow standardized and proven methodologies. Anomalies may be identified based on deviations of model outputs, which may facilitate further analysis and processes to identify the cause or driver behind the identified anomalies. Additional methodologies for validating model outputs may include peer review and challenge techniques, in which the calculations and their accuracy are not in question—the focus is instead on determining how well the models represent the real world.

In an aspect, the review phase 410 may also involve performing sensitivity analysis to determine which variables or inputs of a particular model or models have the greatest impact on certain aspect of the output(s). To perform sensitivity analysis, multiple permutations of a model or models may be executed and the results may be analyzed. For example, analysis of the multiple permutations may include comparing the outputs of multiple models to identify which models provide more accurate results for a given set of data. Such analysis may provide a better understanding of model design, allowing more accurate and/or efficient models to be constructed. Performing sensitivity analysis may also include performing linear regression and other statistical analysis techniques on the various permutations of the executed models. Additionally, sensitivity analysis may facilitate calibration of one or more models, such as to account for how variables and/or input data are impacted by the different models or model configurations. The ability to identify how inputs and variables utilized during model execution impact the output(s) may facilitate a better understanding of the limitations and weaknesses of the models and/or how certain aspects of the models are impacted by particular events or characteristics of the input data. If one or more models are identified as being out of date, inaccurate, or otherwise not suitable for further use in one or more scenarios, the one or more models may be retired. The model execution platform may retain the retired models to facilitate reproduction of previously performed modelling processes during an audit or for other purposes.

As explained above, previously used modelling techniques for performing BCBS 239-type analysis, such as CCAR stress testing, could take weeks to complete. Because these modelling techniques took such a long time to execute, it was difficult and often impossible to perform sensitivity analysis prior to a time when the results of the analysis were to be submitted. However, due to the configuration of a modelling execution platform in accordance with aspects of the present disclosure, all models associated with a particular execution cycle may be completed in a much shorter amount of time 30 minutes). Thus, embodiments of the present disclosure may enable sensitivity analysis to be performed for multiple model execution cycles, allowing sensitivity analysis to be performed during each execution cycle. This capability may facilitate various tuning operations to be performed to adjust the models, the input data, and/or the order of model execution to ensure more accurate results are produced (e.g., for submission to a regulatory authority or for other purposes). As described in more detail below, such adjustments may be applied during an overlays and adjustments phase 412. In an aspect, the objective of sensitivity analysis may be to identify the inputs that have the greatest bearing on the outputs. Once the drivers that have the greatest impact are known, attention can be focused on increasing accuracy and confidence on these inputs. Put another way, sensitivity analysis may enable the user to optimize where to invest time in order to lower the margin of error with respect to the results.

If any problems, anomalies, potential refinements, enhancements, or other inconsistencies are identified during the review phase 410, an overlays and adjustments phase 412 may be initiated. During the overlays and adjustments phase 412, various aspects of the model execution phase 408 may be tuned. For example, for certain types of model-based analysis, such as CCAR stress testing, a modelling process may be utilized to project various aspects of a financial institutions operations (e.g., balance sheets, liquidity, monetary reserves, and the like) under a particular scenario. These projections may provide an approximation of the expected state of the financial institution's operations under the conditions defined by the scenario. However, some aspects of the modelling process may need to be refined to improve the accuracy of the projections. For example, during the review phase it may be determined that an output associated with execution of a particular model projected a market share of 3%, but based on the analysis performed during the review phase the market share should have been 4%. In such an instance, the adjustments or overlays to the outputs and/or inputs of the model execution phase may be utilized to tune a subsequent execution of the model execution phase in which the adjustments are taken into account, thereby resulting in more accurate results being obtained.

As another example, overlays and adjustments applied during the adjustments and overlays phase to account for management and/or strategic decisions. To illustrate, input data for a particular model designed to predict operations of an entity at a future point in time may include data associated with a particular market segment, but it may be known that the entity is exiting the particular market segment on specific point in time, which may fall outside the scope of the model's execution or at an intermediate point between a start and end of a time period within the scope of the model's execution. In these situations, adjustments and overlays may be applied to ensure that these factors are accounted for during the model execution phase, thereby resulting in more accurate outputs being generated. When overlays and/or adjustments are applied to model outputs/inputs, information associated with dependencies of downstream models can be updated to propagate those changes to downstream models, further improving the accuracy of the modeled outputs.

To illustrate, suppose a financial institution closed its wealth management operations in a particular region are a particular point in time, and a model execution phase is performed that takes the financial institutions wealth management operations into account over a 9 quarter time horizon that encompasses the particular point in time. A particular model may generate outputs that include data representative of the financial institution's wealth management operations after the particular point in time, but an overlay or adjustment may be used to change the outputs to null values (or some other value) that would result in the model's execution more accurately accounting for the portion of the time horizon after the wealth management operations were discontinued (e.g., the time period between the particular point in time and the end of the ninth quarter). in an aspect, in addition to adjusting execution of downstream models to account for any applied adjustments and overlays, the model execution engine may analyze any previously executed models to determine whether any of those models should be re-executed to account for the change and if any previously executed models are identified, may initiate re-execution of those models based on the changes.

In an aspect, overlays and adjustments may be associated with one or more layers and/or classifications. For example, overlays or adjustments may be created and applied to the modelling process for various reasons and each reason may be associated with a different classification. Associating overlays and adjustments with different classifications may enable tuning of the modelling process to be applied in a more robust mariner, such as to apply overlays and adjustments under certain modelling conditions (e.g., conditions corresponding to the reason associated with the classification) and to not apply the overlays and adjustments under other modelling conditions. For example, where overlays and adjustments are associated with inputs derived from a data set (e.g., at least a portion of the historical data 119A of FIG. 1), those adjustments and overlays may be applied to other models utilizing similar or the same data sets as inputs, hut application of overlays associated with outputs of models executed earlier in the modelling phase may be limited to models that utilize outputs of those other models as inputs. As another example, overlays and adjustments applied to account for strategy changes, such as changes in a business plan, may only be applied when the modelling process is configured to account for such changes, while models that do not account for such changes may not apply the adjustments and overlays despite possibly utilizing the same underlying data sets as inputs.

A projections results analysis phase 414 may be performed may be performed following completion of the execution cycle 406. As described above, the projections results analysis phase 414 may produce one or more outputs, such as a report that may be provided to a regulatory authority or another entity, such as a board of directors, project managers, or other decision makers associated with the entity evaluated by the modelling process. In an aspect, rather than producing a report, the outputs of the execution cycle 406 may include a set of performance metrics representative of the various evaluated models, and the projections results and analysis phase 414 may involve operations to format the outputs in a manner that is suitable for the appropriate audience. The operations may include presenting one or more graphical user interfaces providing interactive tools to compose a report suitable for submission to a regulatory agency or other relevant authority.

As shown above, modelling platforms in accordance with the present disclosure may facilitate automatic execution of a set of models more quickly and produce more accurate results as compared to existing modelling technologies and techniques, which commonly rely on manual procedures, such as copying an pasting information into spreadsheet programs like Microsoft Excel® and/or using multiple non-integrated and/or incompatible modelling tools. Additionally, a modelling platform according to embodiments is configured to produce output metrics that are deterministic even when the underlying data that was originally used to execute the set of models has changed. Thus, as data changes more accurate output metrics may be obtained by executing the set of models on the altered data, but output metrics produced by executions of the set of models prior to the data alteration may be accurately reproduced, thereby allowing changes in the output metrics to be proved up (e.g., demonstrated as accurate at the time of execution of the set of models). Thus, the disclosed modelling platforms improve the speed at which one or more computers configured to implement a modelling platform operate to complete an execution of a set of models, produce more accurate model outputs, and operate in a deterministic manner despite changes to underlying data sets over time.

In order to address various issues and advance the art, the entirety of this application for MODELLING APPARATUSES, METHODS, AND SYSTEMS (including the Cover Page, Title, Headings, Field, Background, Summary, Brief Description of the Drawings, Detailed Description, Claims, Abstract, Figures, and otherwise) shows, by way of illustration, various embodiments in which the claimed innovations may be practiced. The advantages and features of the application are of a representative sample of embodiments only, and are not exhaustive and/or exclusive. They are presented only to assist in understanding and teach the claimed principles. It should be understood that they are not representative of all claimed innovations. As such, certain aspects of the disclosure have not been discussed herein. That alternate embodiments may not have been presented for a specific portion of the innovations or that further undescribed alternate embodiments may be available for a portion is not to be considered a disclaimer of those alternate embodiments. It will be appreciated that many of those undescribed embodiments incorporate the same principles of the innovations and others are equivalent. Thus, it is to be understood that other embodiments may be utilized and functional, logical, operational, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the innovations, and inapplicable to others. In addition, the disclosure includes other innovations not presently claimed. Applicant reserves all rights in those presently unclaimed innovations including the right to claim such innovations, file additional applications, continuations, continuations in part, divisions, and/or the like thereof. As such, it should be understood that advantages, embodiments, examples, functional, features, logical, operational, organizational, structural, topological, and/or other aspects of the disclosure are not to be considered limitations on the disclosure as defined by the claims or limitations on equivalents to the claims. It is to be understood that, depending on the particular needs and/or characteristics of a modelling platform individual and/or enterprise user, database configuration and/or relational model, data type, data transmission and/or network framework, syntax structure, and/or the like, various embodiments of the modelling platform, may be implemented that enable a great deal of flexibility and customization.

Although embodiments of the present application and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps. Moreover, the scope of the present application is not intended to be limited to the particular embodiments of the process, machine, manufacture, composition of matter, means, methods and steps described in the specification.

1. A method comprising:
compiling, by one or more processors of a modelling platform, a plurality of data sets;
validating, by the one or more processors of the modelling platform, the plurality of data sets, wherein the validating is configured to verify that each of the plurality of data sets satisfies one or more modelling criteria;
determining, by the one or more processors of the modelling platform, model execution parameters for executing a set of models selected from among a plurality of models accessible to the modelling platform, wherein the model execution parameters identify one or more data sets of the plurality of data sets that are to be provided as inputs during execution of each model included in the set of models and identifying an execution order for the set of models, wherein the execution order identifies dependencies between the models included in the set of models, and wherein a dependency between a first model and a second model indicates that an output of the first model is to be provided as an input during execution of the second model;
automatically executing, by the one or more processors of the modelling platform, the set of models in accordance with the execution order to produce an output metric, wherein the output metric represents a cumulative result of execution of the set of models;
creating, by the one or more processors of the modelling platform, a database record representative of the model execution parameters utilized to execute the set of models; and
storing, by the one or more processors of the modelling platform, the database record in a database accessible to the modeling platform.

2. The method of claim 1, wherein the plurality of models accessible to the modelling platform includes at least one of models hosted by the modelling platform and third party models accessible to the modelling platform via a network communication link.

3. The method of claim 1, wherein the set of models is configured to represent a scenario corresponding to a possible real world event, and wherein the output metric represents the impact that the real world event would have if the scenario occurred.

4. The method of claim 3, wherein the scenario is specified by a government agency that regulates a particular industry, and wherein the output metric represents the impact that the real world event would have on an entity involved in the particular industry if the scenario occurred.

5. The method of claim 3, further comprising generating, by the one or more processors of the modelling platform, a report that indicates the impact that the real world event would have if the scenario occurred.

6. The method of claim 5, further comprising determining, by the one or more processor, one or more measures to counteract the impact that the real world event would have if the scenario occurred, wherein the one or more measures are included in the report.

7. The method of claim 1, wherein the execution order is configured to enhance the output metric by executing models that have inputs depending upon outputs of other models after the other models have been executed.

8. The method of claim 1, further comprising:
detecting, by the one or more processors of the modelling platform, alterations of data included in the plurality of data sets; and
creating, by the one or more processors of the modelling platform, change records identifying the alterations of the data included in the plurality of data sets; and
storing, by the one or more processors of the modelling platform, the change records at the database.

9. The method of claim 8, further comprising timestamping, by the one or more processors of the modelling platform, the database records and the change records.

10. The method of claim 9, further comprising:
receiving, by the one or more processors of the modelling platform, an audit request that requests reproduction of the output metric subsequent to the alteration of the data included in the plurality of data sets; and
performing, by the one or more processors of the modelling platform, a subsequent execution of the set of models based on the database records and the change records, wherein an output metric resulting from the subsequent execution of the set of models is the same as the output metric.

11. The method of claim 8, further comprising executing, by the one or more processors of the modelling platform, the set of models based on the alteration of the data included in the plurality of data sets to produce an altered output metric.

12. The method of claim 1, wherein each of the plurality of data sets is associated with a validation information, and wherein, for a particular data set of the plurality of data sets, the validation information indicates whether the particular data set has been authorized for use as an input data set during execution of one or more models of the plurality of models.

13. The method of claim 12, wherein validation information indicates that a corresponding data set has been authorized for use as an input data set during execution of a first model of the set of models but not as an input data set during execution of a second model of the set of models.

14. A non-transitory computer-readable storage medium storing instructions that, when executed by one or more processors, cause the one or more processors to perform operations comprising:
compiling a plurality of data sets;
validating, by the one or more processors of the modeling platform, the plurality of data sets, wherein the validating is configured to verify that each of the plurality of data sets satisfies one or more modelling criteria;
determining, by the one or more processors of the modelling platform, model execution parameters for executing a set of models selected from among a plurality of models accessible to the modelling platform, wherein the model execution parameters identify one or more data sets of the plurality of data sets that are to be provided as inputs during execution of each model included in the set of models and identifying an execution order for the set of models, wherein the execution order identifies dependencies between the models included in the set of models, and wherein a dependency between a first model and a second model indicates that an output of the first model is to be provided as an input during execution of the second model;
automatically executing by the one or more processors of the modelling platform, the set of models in accordance with the execution order to produce an output metric, wherein the output metric represents a cumulative result of execution of the set of models;
creating, by the one or more processors of the modelling platform, a database record representative of the model execution parameters utilized to execute the set of models; and
storing, by the one or more processors of the modelling platform, the database record in a database accessible to the modeling platform.

15. The non-transitory computer-readable storage medium of claim 14, wherein the plurality of models accessible to the modelling platform includes at least one of models hosted by the modelling platform and third party models accessible to the modelling platform via a network communication link.

16. The non-transitory computer-readable storage medium of claim 14, wherein the set of models is configured to represent a scenario corresponding to a possible real world event, and wherein the output metric represents the impact that the real world event would have if the scenario occurred.

17. The non-transitory computer-readable storage medium of claim 16, wherein the scenario is specified by a government agency that regulates a particular industry, and wherein the output metric represents the impact that the real world event would have on an entity involved in the particular industry if the scenario occurred.

18. The non-transitory computer-readable storage medium of claim 16, the operations comprising:
generating a report that indicates the impact that the real world event would have if the scenario occurred;
determining one or more measures to counteract the impact that the real world event would have if the scenario occurred, wherein the one or more measures are included in the report.

19. The non-transitory computer-readable storage medium of claim 14, the operations further comprising:
detecting, by the one or more processors of the modelling platform, alterations of data included in the plurality of data sets; and
creating, by the one or more processors of the modelling platform, change records identifying the alterations of the data included in the plurality of data sets;
storing, by the one or more processors of the modelling platform, the change records at the database; and
timestamping, by the one or more processors of the modelling platform, the database records and the change records.

20. A system comprising:
a memory; and
one or more processors communicatively coupled to the memory and configured to:
compile, by one or more processors of a modelling platform, a plurality of data sets;
validate the plurality of data sets, wherein the validating is configured to verify that each of the plurality of data sets satisfies one or more modelling criteria;
determine model execution parameters for executing a set of models selected from among a plurality of models accessible to the modelling platform, wherein the model execution parameters identify one or more data sets of the plurality of data sets that arc to be provided as inputs during execution of each model included in the set of models and identifying an execution order for the set of models, wherein the execution order identifies dependencies between the models included in the set of models, and wherein a dependency between a first model and a second model indicates that an output of the first model is to be provided as an input during execution of the second model;
automatically execute the set of models in accordance with the execution order to produce an output metric, wherein the output metric represents a cumulative result of execution of the set of models;
create a database record representative of the model execution parameters utilized to execute the set of models;
store, by the one or more processors of the modelling platform, the database record in a database accessible to the modeling platform; and
generate a report that indicates the impact that the real world event would have if the scenario occurred.
